(19) United States
(12) Patent Application Publication
(10) Pub. No.: US 2021/0142452 A1
(43) Pub. Date: May 13, 2021

(54) METHOD AND APPARATUS FOR PROCESSING 360-DEGREE IMAGE

(71) Applicant: Samsung Electronics Co., Ltd., Suwon-si, Gyeonggi-do (KR)

(72) Inventors: Albert SAA-GARRIGA, Middlesex (GB); Alessandro VANDINI, Middlesex (GB); Tommaso MAESTRI, Middlesex (GB)

(21) Appl. No.: 16/606,004

(22) PCT Filed: May 11, 2018
(86) PCT No.: PCT/KR2018/005440

§ 371 Date: Oct. 17, 2019

(30) Foreign Application Priority Data
May 18, 2017 (GB) 1708001.1
Apr. 19, 2018 (KR) 10-2018-0045741

(51) Int. Cl. G06T 5/00; G06T 5/40; G06T 3/60; G06T 7/20; G06N 20/00

(52) U.S. Cl. CPC G06T 5/006; G06T 5/40; G06T 2207/20024; G06T 7/20; G06N 20/00; G06T 3/60

(57) ABSTRACT

Provided is a method of processing a 360-degree image that includes: obtaining a plurality of motion vectors for a 360-degree image, determining at least one motion vector, which indicates global rotation of the 360-degree image, among the plurality of motion vectors through filtering; performing three-dimensional-transformation on the determined at least one motion vector so as to acquire three-dimensional rotation information of the 360-degree image, and correcting distortion, of the 360-degree image, caused by shaking, based on the acquired three-dimensional rotation information.

### TECHNICAL FIELD

The present disclosure relates to a method of processing a 360-degree image, an apparatus for processing a 360-degree image, and a recording medium having recorded thereon a program for executing the method.

### BACKGROUND ART

With developments in image processing technology, research into a method of providing a 360-degree image has been actively conducted as one of techniques for providing realistic images to users. When a 360-degree image is provided, a so-called virtual reality (VR) sickness problem, which is similar to motion sickness, arises while users are viewing 360-degree images. The VR sickness may occur due to sensory conflict while the users are viewing the 360-degree images. The VR sickness may be alleviated by correcting undesirable camera motions and stabilizing images.

Such image stabilization may be performed during post-processing of the images, and most image stabilization techniques require two separate operations. First of all, unintentional camera motions have to be detected from a predicted tracking movement_of a camera and restricted, and secondly, a new image sequence has to be generated by using stable tracking of the camera and an original image sequence. However, it is difficult to predict tracking movement of the camera in a single point imaging system that is not corrected and to reliably perform the generation of new images with a stabilized camera view, and thus additional research is needed to stabilize the 360-degree image.

### DESCRIPTION OF EMBODIMENTS

### Technical Problem

Provided are a method of processing a 360-degree image to enable stabilization of an image by translating a motion vector of the 360-degree image into rotation information and correcting distortion, caused by shaking, in the 360-degree image, and an apparatus for processing a 360-degree image.

### Solution to Problem

According to an aspect of the present disclosure, a method of processing a 360-degree image, includes: obtaining a plurality of motion vectors regarding the 360-degree image; determining at least one motion vector indicating global rotation of the 360-degree image from among the plurality of motion vectors, through filtering; obtaining three-dimensional (3D) rotation information of the 360-degree image by three-dimensionally translating the determined at least one motion vector; and correcting distortion of the 360-degree image, which is caused by shaking, based on the obtained 3D rotation information.

The determining of the at least one motion vector may include removing a motion vector, which is included in a predetermined area, from the plurality of motion vectors according to types of projections.

The determining of the at least one motion vector may include: generating a mask based on an edge detected from the 360-degree image; determining an area of the 360-degree image, where texture does not exist, by applying the generated mask to the 360-degree image; and removing a motion vector included in the area, where texture does not exist, from among the plurality of motion vectors.

The determining of the at least one motion vector may include: detecting at least one moving object from the 360-degree image through a preset object detection process; and removing motion vector, which is related to the detected object, from the plurality of motion vectors.

The determining of the at least one motion vector may include determining, as motion vectors indicating the global rotation, motion vectors that are parallel to each other on opposite sides of a unit sphere, to which the 360-degree image is projected, have different marks, and have sizes within a predetermined threshold range.

The obtaining of the 3D rotation information may include: classifying the determined at least one motion vector into a plurality of bins corresponding to a predetermined direction and predetermined size ranges; selecting a bin including the greatest number of motion vectors from among the plurality of classified bins; and obtaining the 3D rotation information by translating a direction and a distance of the selected bin.

In the obtaining of the 3D rotation information, the 3D rotation information may be obtained by applying a weighted average to directions and distances of the selected bin and a plurality of adjacent bins.

The obtaining of the 3D rotation information may include obtaining, as the 3D rotation information, a rotation value that minimizes a sum of the determined at least one motion vector.

The obtaining of the 3D rotation information may include obtaining the 3D rotation information based on the plurality of motion vectors by using a learning network model that is previously generated.

The method may further include obtaining sensor data generated as a result of sensing shaking of a capturing device when the 360-degree image is captured, and the correcting of the 360-degree image may include correcting the distortion of the 360-degree image by combining the obtained sensor data with the 3D rotation information.

According to an aspect of the present disclosure, an apparatus for processing a 360-degree image includes: a memory storing one or more instructions; and a processor configured to execute the one or more instructions stored in the memory, wherein the processor is configured to: obtain a plurality of motion vectors regarding a 360-degree image; determine at least one motion vector indicating global rotation of the 360-degree image from among the plurality of motion vectors through filtering; obtain three-dimensional (3D) rotation information regarding the 360-degree image by three-dimensionally translating the determined at least one motion vector; and correct distortion of the 360-degree image which is caused by shaking, based on the obtained 3D rotation information.

### BRIEF DESCRIPTION OF DRAWINGS

FIG. 1 is a diagram for explaining a format in which a 360-degree image is stored, according to an embodiment.

FIG. 2 is a flowchart of a method in which an image processing apparatus processes a 360-degree image, according to an embodiment.

FIG. 3 is a flowchart for explaining in detail a method in which an image processing apparatus processes a 360-degree image, according to an embodiment.

FIG. 4 is a diagram for explaining a motion vector of a 360-degree image, according to an embodiment.

FIG. 5 is a diagram of a method in which an image processing apparatus removes a motion vector of a preset area from motion vectors through filtering, according to an embodiment.

FIG. 6 is a diagram of a method in which an image processing apparatus removes a motion vector included in a texture free area through filtering, according to an embodiment.

FIG. 7 is a diagram for describing a method, performed by an image processing apparatus, of removing a motion vector through filtering, the image processing apparatus having determined that the motion vector is not global rotation, according to an embodiment.

FIG. 8 is a flowchart of a method in which an image processing apparatus determines a motion vector indicating global rotation through filtering, according to an embodiment.

FIG. 9 is a flowchart of a method in which an image processing apparatus translates a motion vector into three-dimensional (3D) rotation, according to an embodiment.

FIG. 10 is a diagram of a motion vector of a 360-degree image, according to an embodiment.

FIG. 11 shows tables for explaining results of classifying motion vectors into bins, according to an embodiment.

FIG. 12 is a histogram showing the classified motion vectors of FIG. 11, according to an embodiment.

FIG. 13 is a flowchart of a method in which an image processing apparatus re-determines rotation information by combining sensing data regarding shaking and rotation information obtained based on a motion vector of a 360-degree image, according to an embodiment.

FIG. 14 is a block diagram of an image processing apparatus, according to an embodiment.

FIG. 15 is a diagram of at least one processor, according to an embodiment.

FIG. 16 is a block diagram of a data learner, according to an embodiment.

FIG. 17 is a block diagram of a data recognizer, according to an embodiment.

FIG. 18 is a block diagram of an image processing apparatus, according to another embodiment.

### BEST MODE

According to an aspect of the present disclosure, a method of processing a 360-degree image, includes: obtaining a plurality of motion vectors regarding the 360-degree image; determining at least one motion vector indicating global rotation of the 360-degree image from among the plurality of motion vectors, through filtering; obtaining three-dimensional (3D) rotation information of the 360-degree image by three-dimensionally translating the determined at least one motion vector; and correcting distortion of the 360-degree image, which is caused by shaking, based on the obtained 3D rotation information.

The determining of the at least one motion vector may include removing a motion vector, which is included in a predetermined area, from the plurality of motion vectors according to types of projections.

The determining of the at least one motion vector may include: generating a mask based on an edge detected from the 360-degree image; determining an area of the 360-degree image, where texture does not exist, by applying the generated mask to the 360-degree image; and removing a motion vector included in the area, where texture does not exist, from among the plurality of motion vectors.

The determining of the at least one motion vector may include: detecting at least one moving object from the 360-degree image through a preset object detection process; and removing motion vector, which is related to the detected object, from the plurality of motion vectors.

The determining of the at least one motion vector may include determining, as motion vectors indicating the global rotation, motion vectors that are parallel to each other on opposite sides of a unit sphere, to which the 360-degree image is projected, have different marks, and have sizes within a predetermined threshold range.

The obtaining of the 3D rotation information may include: classifying the determined at least one motion vector into a plurality of bins corresponding to a predetermined direction and predetermined size ranges; selecting a bin including the greatest number of motion vectors from among the plurality of classified bins; and obtaining the 3D rotation information by translating a direction and a distance of the selected bin.

In the obtaining of the 3D rotation information, the 3D rotation information may be obtained by applying a weighted average to directions and distances of the selected bin and a plurality of adjacent bins.

The obtaining of the 3D rotation information may include obtaining, as the 3D rotation information, a rotation value that minimizes a sum of the determined at least one motion vector.

The obtaining of the 3D rotation information may include obtaining the 3D rotation information based on the plurality of motion vectors by using a learning network model that is previously generated.

The method may further include obtaining sensor data generated as a result of sensing shaking of a capturing device when the 360-degree image is captured, and the correcting of the 360-degree image may include correcting the distortion of the 360-degree image by combining the obtained sensor data with the 3D rotation information.

According to an aspect of the present disclosure, an apparatus for processing a 360-degree image includes: a memory storing one or more instructions; and a processor configured to execute the one or more instructions stored in the memory, wherein the processor is configured to: obtain a plurality of motion vectors regarding a 360-degree image; determine at least one motion vector indicating global rotation of the 360-degree image from among the plurality of motion vectors through filtering; obtain three-dimensional (3D) rotation information regarding the 360-degree image by three-dimensionally translating the determined at least one motion vector; and correct distortion of the 360-degree image which is caused by shaking, based on the obtained 3D rotation information.

### Mode of Disclosure

The terms used in the specification will be briefly described, and then the disclosure will be described in detail.

The terms used in this specification are those general terms currently widely used in the art in consideration of functions regarding the present disclosure but the terms may vary according to the intention of those of ordinary skill in the art, precedents, or new technology in the art. Also, specified terms may be selected by the applicant, and in this case, the detailed meaning thereof will be described in the detailed description of the present disclosure. Thus, the terms used in the specification should be understood not as simple names but based on the meaning of the terms and the overall description of the disclosure.

While such terms as “first”, “second”, etc., may be used to describe various components, such components must not be limited to the above terms. The above terms are used only to distinguish one component from another. For example, a first component discussed below could be termed a second component, and similarly, a second component could be termed a first component, without departing from the teachings of the disclosure. As used herein, the term “and/or” includes any and all combinations of one or more of the associated listed items.

Throughout the specification, when a portion “includes” an element, another element may be further included, rather than excluding the existence of the other element, unless otherwise described. Also, the term “unit” is a software component or a hardware component such as a field-programmable gate array (FPGA) or an application specific integrated circuit (ASIC) and performs a certain function. However, the “unit” is not limited to software or hardware. The “unit” may be configured to be included in a storage medium on which addressing may be performed or may be configured to execute one or more processors. Therefore, the “unit” includes components (e.g., software components, object-oriented software components, class components, and task components), processes, functions, attributes, procedures, sub-routines, segments of program codes, drivers, firmware, micro codes, circuits, data, database, data structures, tables, arrays, and variables. Components and functions provided in the “units” may be combined into a smaller number of components and “units” or separated into additional components and “units”.

With reference to the accompanying drawings below, it will be described in detail so that one of ordinary skill in the art may easily perform embodiments of the disclosure. However, one or more embodiments of the present disclosure may be embodied in many different forms and should not be construed as being limited to the embodiments set forth herein. For clarity, portions that are irrelevant to the descriptions of the disclosure are omitted, and throughout the specification, like reference numerals in the drawings denote like elements.

FIG. 1 is a diagram for explaining a format in which a 360-degree image is stored, according to an embodiment.

Referring to FIG. 1, the 360-degree image may be stored in various formats. For example, according to unit sphere representation, pixels forming frames of the 360-degree image may be indexed to a three-dimensional (3D) coordinate system defining locations of respective pixels on a surface of a virtual sphere 110.

However, this is merely an example, and according to another example, 2D equivalent representation such as a cube map projection 120 or an equi-rectangular projection 130 may be used. In the cube map projection 120, image data regarding each surface of a virtual cube may be stored as a 2D image having a field of view of 90×90 degrees. Also, in the equi-rectangular projection 130, image data may be stored as a single 2D image having a field of view of 360×180 degrees.

Labels of FIG. 1, for example, an ‘upper portion’, a ‘lower portion’, a ‘front surface’, a ‘rear surface’, a ‘left side’, and a ‘right side’ respectively indicate corresponding areas of the 360-degree image, in the above-described equivalent projection. However, the formats of FIG. 1 are merely examples, and according to another embodiment, the 360-degree image may be stored in a format different from the format of FIG. 1.

FIG. 2 is a flowchart of a method in which an image processing apparatus processes a 360-degree image, according to an embodiment.

In operation S210, the image processing apparatus may obtain motion vectors regarding the 360-degree image. Examples of motion vectors regarding the 360-degree image in 2D image data are shown in FIG. 4.

FIG. 4 is a diagram for explaining a motion vector of a 360-degree image, according to an embodiment.

The motion vector may be information used to explain a displacement of a certain area 411 of an image between a reference frame 401 and a current frame 402. In the present embodiment, a previous frame of an image is selected as the reference frame 401, but in another embodiment, a discontinuous frame may be used as a reference frame to calculate a motion vector. In the present embodiment, to fully use a wide field of view of the 360-degree image, motion vectors may be obtained at points that are evenly distributed throughout the frame.

FIG. 4 shows V that is a 2D motion vector, but according to another embodiment, 3D motion vectors may be obtained. For example, when image data regarding a current frame is stored by using the unit sphere representation of FIG. 1, the 3D motion vectors may be obtained.

The motion vectors obtained in the present embodiment are motion vectors that are generated before image data of a frame of the 360-degree image is encoded. The motion vector may be generally generated and stored during an existing image encoding process such as MPEG 4.2 or H.264 encoding. While the image is encoded, the motion vectors may be used to compress image data by re-using a block of the previous frame to draw a next frame. A detailed method of generating a motion vector will be omitted.

The motion vector that is previously generated may be retrieved from a stored 360-degree image file. The re-use of the motion vectors according to the above-described method may decrease the entire processing load. According to another method, when the 360-degree image file does not include the motion vectors, the motion vectors may be generated in operation S210.

In operation S220, the image processing apparatus may determine at least one motion vector indicating global rotation of the 360-degree image from among the motion vectors through filtering.

Here, the expression ‘global rotation’ indicates rotation affecting the image in the whole frames, unlike local rotation that partially affects the image. The global rotation may be a result obtained as a camera rotates while the image is captured, or a result obtained as a large part of a frame moves around the camera in the same manner. For example, when a 360-degree image is captured in a vehicle that moves, global rotation may occur in the background due to the rotation of the vehicle and may occur in every part of the vehicle shown in the background and the foreground due to the rotation of the camera itself. Rotation may be considered as ‘global rotation’ when affecting most part of a frame.

Examples of motion vectors that do not indicate global rotation may include a motion vector that is related to an object that moves less in a scene or a motion vector that is related to a static object that appears not to rotate when the camera rotates because the static object is fixed with respect to the camera.

The image processing apparatus according to an embodiment may perform filtering to remove a motion vector included in an area that is previously determined from among the motion vectors. This will be described in more detail with reference to FIG. 5.

Also, an image processing apparatus according to another embodiment may generate a mask based on an edge detected from the 360-degree image by performing filtering and may remove a motion vector included in a texture-free area from the 360-degree image by applying the generated mask to the 360-degree image. This will be described in more detail with reference to FIG. 6.

An image processing apparatus according to another embodiment may perform filtering to remove a motion vector that is related to an object moving on the 360-degree image.

An image processing apparatus according to another embodiment may perform filtering by determining whether a motion vector, which is on an opposite side of a unit sphere, satisfies a predetermined condition and whether the motion vector indicates the global rotation. This will be described in more detail with reference to FIG. 7.

The image processing apparatus may combine at least two of the above-described filtering methods and may remove a motion vector that does not indicate the global rotation from among the motion vectors. Also, the aforementioned examples are merely examples of methods of filtering motion vectors, and other filtering methods may be used. Another embodiment, in which the motion vector may be filtered, may include static object filtering, background flow subtraction, and manual filtering, but examples are not limited thereto. During the static object filtering, a static object, which does not move from one frame to a next frame, may be detected, and motion vectors regarding the static object may be filtered. Examples of types of the static object that may be detected in the 360-degree image may include black pixels of a lens, a finger of a user in front of the camera, or the like.

During the background flow subtraction, background pixels, which move at a constant rate in the entire image, may be excluded under the assumption that the background pixels do not include significant information used to calculate stabilizing rotation. The manual filtering may include a human operator who manually filters motion vectors.

In operation S230, the image processing apparatus may obtain 3D rotation information regarding the 360-degree image by three-dimensionally translating determined at least one motion vector.

The image processing apparatus according to an embodiment may classify determined at least one motion vector into bins corresponding to a predetermined direction and predetermined size ranges. The image processing apparatus may covert a direction and a distance of a bin including the greatest number of motion vectors from among the classified bins, thereby obtaining 3D rotation information. However, this is merely an example, and according to another example, the image processing apparatus may obtain the 3D rotation information by applying a weighted average to directions and distances of the bin, which includes the greatest number of motion vectors, and bins adjacent to the bin.

The image processing apparatus according to another embodiment may obtain, as the 3D rotation information, a rotation value that minimizes a sum of at least one determined motion vector.

The image processing apparatus according to another embodiment may obtain the 3D rotation information based on the motion vectors, by using a learning network model that is previously generated.

For example, when a person's body rotates, the person may analyze an image shift (which is similar to a motion vector) caused by motion due to an environment and may stabilize his/her gaze by maintaining eye level. Similar actions may also be observed in a simple sample such as a fly having a relatively small number of neurons.

Neurons may convert sensory information into a format corresponding to motor system requirements. Therefore, in an embodiment based on artificial intelligence (AI), a machine learning mechanism may be used to imitate actions of living things and obtain sensor rotation translation by using motion vectors as input data. Also, in an embodiment based on AI, a machine learning system may be used that is the same as a learning network model that trains with regard to patterns of motion vectors in a frame having predetermined rotation. Such mechanisms tend to imitate living things and may output overall rotation for stabilizing the 360-degree image by receiving motion vectors as inputs.

In operation S240, the image processing apparatus may correct a distortion of the 360-degree image which is caused by shaking, based on the obtained 360-degree rotation information.

The image processing apparatus may correct the distortion of the 360-degree image, which is caused by shaking, by rotating the 360-degree image based on the 3D rotation information. Also, the image processing apparatus may render and display the corrected 360-degree image or may encode and store the 360-degree image to play the same.

FIG. 3 is a flowchart for explaining in detail a method in which an image processing apparatus processes a 360-degree image, according to an embodiment.

According to an embodiment, all operations of the method of FIG. 3 may be performed by the same apparatus, or each operation may be performed by a different apparatus. Arbitrary operations of FIG. 3 may be performed by software or hardware, according to embodiments. When at least one operation is performed by software, an apparatus for performing the method of FIG. 3 may include a processing unit including at least one processor and a computer-readable memory storing therein executable computer program commands to enable the processing unit to perform the method.

In operation S310, the image processing apparatus may obtain motion vectors regarding a current frame of the 360-degree image.

The image processing apparatus may retrieve a motion vector from the stored 360-degree image file or may obtain motion vectors by generating motion vectors at points that are evenly distributed throughout the frame.

Operation S310 may correspond to operation S210 described above with reference to FIG. 2.

In operation S320, the image processing apparatus may perform filtering on the motion vectors. In particular, in operation S320, the motion vectors may be filtered to remove motion vectors that do not indicate global rotation of the 360-degree image.

For example, the image processing apparatus may perform filtering to remove motion vectors that are related to an object that moves less in a frame, or motion vectors that are related to a static object that seems not to rotate when a camera rotates because the static object is fixed with respect to the camera. Examples of various methods of filtering motion vectors will be described in detail with reference to FIGS. 5 to 7.

According to another embodiment, the motion vectors may not be filtered, and in this case, operation S320 may be omitted.

In operation S330, the image processing apparatus may translate the motion vectors into 3D rotation.

The image processing apparatus may remove a motion vector that does not indicate the global rotation by filtering the motion vectors and then may translate remaining motion vectors into the 3D rotation that may be applied to a current frame to stabilize the 360-degree image.

For example, the 360-degree image may be stored as 2D image data through equi-rectangular projection, and a predefined translation may be used to translate the motion vector into the 3D rotation. The pre-defined translation may be defined in advance based on the geometry of 2D projection. In the present embodiment, translation using the following Equation 1 may be used.

$${R}_{x} = \frac{180}{width} \times v \\ {R}_{y} = \frac{180}{width} \times v \\ {R}_{z} = \frac{180}{height} \times v \qquad Equation 1$$

In Equation 1, Rx, Ry, and Rz may respectively indicate rotation with respect to x, y, and z axes in degree units, a width may indicate a total width of a field of view in pixel units, a height may indicate a total height of a field of view in pixel units, and a motion vector v may be expressed, for example, as (13, 8) indicating 13-pixel translation in an x-axis direction and 8-pixel translation in a y-axis direction. In the present embodiment, it is assumed that a frame width in the horizontal direction is 36 pixels, and a degree per pixel is 10 degrees.

Therefore, according to Equation 1, a horizontal component of a motion vector may be converted into equivalent rotation on a z axis of (360/36)*13=130 degrees. Also, a vertical component of the motion vector may be converted into equivalent rotation on an x axis or a y axis according to a location of the motion vector in a frame.

Overall rotation required to stabilize the 360-degree image may be expressed as 3D rotation, that is, rotation in a 3D space. The rotation may be expressed by three separated rotation components like axes, for example, the x, y, and z axes of FIG. 1, which are perpendicular to each other. The rotation obtained in operation S330 may be referred to as stabilizing rotation because it is possible to effectively correct shaking of the camera and stabilize the 360-degree image.

Overall rotation applied to stabilize the 360-degree image may be determined in various manners. For example, as described above, each motion vector may be converted into equivalent rotation, and average rotation (e.g., an average or a mode) of all frames may be considered as the overall rotation. In some embodiments, Gaussian or median filters may be used when an average is taken by considering an average or a value around a mode value. Also, according to another embodiment, an average motion vector may be calculated with regard to all frames and may be converted into the overall rotation by using the pre-defined translation.

Above Equation 1 may be amended according to the necessity in other embodiments. For example, when the 360-degree image is stored in a 3D format such as unit sphere representation, above Equation 1 may be amended.

In operation S340, the image processing apparatus may provide 3D rotation to an image processing unit in order to generate a stabilized image.

In operation S350, the image processing apparatus may generate the stabilized image by applying the 3D rotation to the image data of the current frame.

Also, the image processing apparatus may render and display the stabilized image or may encode and store the stabilized image to play the same. In some embodiments, the stabilized image may be encoded through inter-frame compression. In such embodiments, based on rotation applied to stabilized image data, effective compression may be achieved. During the above-described image stabilization process, frames of an original 360-degree image are edited in a manner that a difference between image data of two continuous frames is minimized, and thanks to this, an encoder may re-use a lot of information of previous frames, and thus, a lower bitrate may be used when inter-frame compression is used. As a result, the amount of generated key frames may decrease, and accordingly, a compression rate may be improved.

According to another embodiment, analysis for determining rotation for stabilizing an image may be performed in a first image processing apparatus, and operation S350 of generating the stabilized image may be performed by a second image processing apparatus that is physically separated from the first image processing apparatus. For example, in some embodiments, the first image processing apparatus may set a value of a 3D rotation parameter in metadata regarding the 360-degree image, according to the determined rotation.

In operation S340, the first image processing apparatus may provide the second image processing apparatus with metadata and relevant image data by using an appropriate mechanism such as broadcast signals or network connection. The second image processing apparatus may obtain a value of a 3D rotation parameter from metadata used to determine the rotation. Then, in operation S350, the second image processing apparatus may generate the stabilized 360-degree image by applying, to the 360-degree image, rotation defined by using the 3D rotation parameter. Also, the second image processing apparatus according to some embodiments may generate the stabilized 360-degree image by applying, to rotated image data, rotation and/or translation defined according to a camera control input before rendering is performed on the rotated image data.

FIG. 5 is a diagram of a method in which an image processing apparatus removes a motion vector of a preset area from motion vectors through filtering, according to an embodiment.

Referring to FIG. 5, a distance between an upper area 511 and a lower area 512 tends to be exaggerated in equi-rectangular projection, and thus, when the equi-rectangular projection is used, motion vectors of the upper area 511 and the lower area 512 of a frame 500 may potentially include a great error.

Accordingly, when the equi-rectangular projection is used, the image processing apparatus may remove the motion vectors of the upper area 511 and the lower area 512 from among the motion vectors when rotation for stabilizing the 360-degree image is calculated.

FIG. 6 is a diagram of a method in which an image processing apparatus removes a motion vector included in a texture free area through filtering, according to an embodiment.

Referring to FIG. 6, the image processing apparatus may detect edges of a frame and may dilate the detected edges, thereby generating a mask. The image processing apparatus may apply the mask to the frame to remove a texture-free area that actually has no texture.

In an example of FIG. 6, black pixels in the mask indicate areas where edges are not detected, which may mean areas where texture does not actually exist. For example, thresholding may be performed to make the mask only include a pixel value of 1 or 0, and referring to FIG. 6, 1 indicates white pixels, and 0 indicates black pixels. The image processing apparatus may compare a location of a motion vector of the 360-degree image with the pixel value of the mask, and when the mask has the pixel value of 0 at the location, the image processing apparatus may perform filtering by discarding the motion vector.

In the present embodiment, a case where the motion vector of the texture-free area is removed through filtering has been described, but according to another embodiment, a motion vector may be filtered from an area of another type that may include an unreliable motion vector. Examples of areas of different types that may include unreliable motion vectors may include areas showing chaotic movements such as maple leaves or smoke.

FIG. 7 is a diagram for describing a method, performed by an image processing apparatus, of removing a motion vector through filtering, the image processing apparatus having determined that the motion vector is not global rotation, according to an embodiment.

Referring to FIG. 7, the image processing apparatus may perform filtering based on the fact that, in the 360-degree image, a motion vector having a similar size and an opposite direction is generated through global rotation on an opposite side surface of the unit sphere. In particular, the image processing apparatus may compare a reference point of the unit sphere or at least one neighboring motion vector with at least one corresponding motion vector on an opposite side surface of the sphere unit, which is referred to as a “mirroring point” and thus may determine whether the motion vector is related to the global rotation.

When two motion vectors on opposite sides have sizes within a predetermined threshold value (e.g., ±10%), are parallel to each other, and have marks in opposite directions, the image processing apparatus may determine that the motion vectors indicate the global rotation. When it is determined that the motion vectors indicate the global rotation, the image processing apparatus may use the motion vectors to determine rotation for stabilizing the 360-degree image.

FIG. 8 is a flowchart of a method in which an image processing apparatus determines a motion vector indicating a global rotation through filtering, according to an embodiment.

Operations S810 to S890 described with reference to FIG. 8 may be performed between operations S310 and S330 described with reference to FIG. 3.

In operation S810, the image processing apparatus may filter a motion vector of at least one area from among the motion vectors of the 360-degree image. For example, when the equi-rectangular projection is used in the 360-degree image, the image processing apparatus may remove the motion vector from an upper area and a lower area of the 360-degree image through filtering.

In operation S820, the image processing apparatus may generate a mask for filtering the texture-free area. For example, the image processing apparatus may detect edges regarding the 360-degree image and may dilate the detected edges, thereby generating a mask.

In operation S830, the image processing apparatus may apply the mask to the current frame to filter the motion vector of the texture-free area. For example, the image processing apparatus may compare a pixel value of the mask with a location of the motion vector in the 360-degree image, and when the mask has the pixel value of 0 (an area where an edge is not detected) at the location, the image processing apparatus may perform filtering by removing the motion vector.

In operation S840, the image processing apparatus may detect a moving object from the 360-degree image. The image processing apparatus may use an appropriate object detection algorithm from among existing object detection algorithms and may detect at least one moving object from the 360-degree image.

In operation S850, the image processing apparatus may perform filtering on a motion vector that is related to the moving object. The image processing apparatus may remove the motion vector that is related to the moving object from among remaining motion vectors after filtering. The motion vector that is related to the moving object may be much greater in size than other motion vectors. Therefore, the image processing apparatus may perform filtering on the motion vector to prevent the stabilizing rotation from being distorted by a large motion vector due to a rapidly moving object.

In operation S860, the image processing apparatus may compare motion vectors on the other side surface of the sphere.

In operation S870, the image processing apparatus may determine whether the motion vector corresponds to the global rotation. For example, when two motion vectors on opposite sides have sizes within a predetermined threshold value (e.g., ±10%), are parallel to each other, and have marks in opposite directions, the image processing apparatus may determine that the motion vectors indicate the global rotation.

In operation S880, because it is determined that the motion vector corresponds to the global rotation, the image processing apparatus may maintain the motion vector.

In operation S890, the image processing apparatus may determine that the motion vector does not correspond to the global rotation and thus may exclude the motion vector when the rotation is calculated.

FIG. 9 is a flowchart of a method in which an image processing apparatus converts a motion vector into 3D rotation, according to an embodiment.

In operation S910,the image processing apparatus may classify motion vectors into bins corresponding to a predetermined size ranges in predetermined directions.

A specific method in which the image processing apparatus classifies the motion vectors into the bins will be described with reference to FIGS. 10 to 12.

FIG. 10 is a diagram of a motion vector of a 360-degree image, according to an embodiment.

FIG. 10 shows the motion vectors of the 360-degree image after the mask of FIG. 6 is applied. In the present embodiment, for convenience of explanation, motion vectors in a horizontal (an x axis) direction are only shown. However, this is merely an example, and the method applied to the present embodiment may expand to motion vectors in another axis to determine 3D rotation.

FIG. 11 shows tables for explaining results of classifying motion vectors into bins, according to an embodiment.

Referring to FIG. 11, a distance related to a predetermined bin may be translated into an equivalent angle by using the predetermined translation described above with reference to operation S330 of FIG. 3. In the present embodiment, it may be identified that the motion vector has a value between −1 and +12.

FIG. 12 is a histogram showing the classified motion vectors of FIG. 11, according to an embodiment.

Referring to FIG. 12, as a result of classification, it is identified that a bin at the distance 7 that is the 20^{th} bin includes the greatest number of motion vectors.

Referring to FIG. 9, in operation S920, the image processing apparatus may identify a bin including the greatest number of motion vectors from among the bins. As described above with reference to FIG. 12, the image processing apparatus may identify that the bin at the distance 7 includes the greatest number of motion vectors.

In operation S930, the image processing apparatus may calculate the rotation by using a weighted average based on the identified bin and an adjacent bin.

In operation S920, the distance 7 corresponding to the identified bin is equivalent to rotation of 0.043 radians (2.46°). The image processing apparatus may determine the rotation for stabilizing the 360-degree image by translating a distance corresponding to the identified bin into equivalent rotation by using certain translation.

In the present embodiment, actual camera rotation is analyzed based on a 360-degree image that is measured in 0.04109753 radians, and it is identified that a value (0.043 radians), which is obtained by translating a distance of the bin including the greatest number of motion vectors from among the bins, is a reasonable estimation of the actual camera rotation.

According to another embodiment, to improve the accuracy of an obtained rotation value, the image processing apparatus may calculate the rotation by using a weighted average of the bin, which is identified in operation S920, and neighboring bins. A 3 amplitude Gaussian weighted average may be an example of the weighted average, but this is merely an example, and other types of weighted averages may be used. In the present embodiment, the weighted average is applied, predicted rotation of 0.04266 radians is obtained, which is closer to 0.04109753 that is the actual camera rotation.

As another alternative to the above-described method of translating the motion vector into the 3D rotation, in another embodiment, rotation may be determined by aggregating motion vectors vj so as to determine the entire motion field M according to following Equation 2 regarding a frame of the 360-degree image.

$$M = {\sum }_{j = 1}^{N} {v}_{j} \qquad Equation 2$$

The 3D rotation for stabilizing the 360-degree image may be obtained by determining rotation R that minimizes the entire motion field as in Equation 3.

$$R = \begin{matrix}argmin M ( {R}_{i} ) \\ {R}_{i}\end{matrix} \qquad Equation 3$$

FIG. 13 is a flowchart of a method in which an image processing apparatus re-determines rotation information by combining sensing data regarding shaking and rotation information obtained based on a motion vector of a 360-degree image, according to an embodiment.

In operation S1310, the image processing apparatus may determine at least one motion vector indicating global rotation of the 360-degree image from among motion vectors regarding the 360-degree image.

Operation S1310 may correspond to operation S220 described above with reference to FIG. 2.

In operation S1320, the image processing apparatus may obtain 3D rotation information by translating the determined at least one motion vector.

Operation S1320 may correspond to operation S230 described with reference to FIG. 2.

In operation S1330, the image processing apparatus may re-determine the rotation information regarding the 360-degree image by combining the rotation information and the sensor data regarding shaking, which are obtained when the 360-degree image is captured.

For example, the image processing apparatus may be set to obtain sensor data regarding shaking of a capturing device while the 360-degree image is captured. The image processing apparatus may consider the sensor data when the rotation is determined. For example, the image processing apparatus may verify rotation information, which is obtained by analyzing the motion vectors based on the sensor data, or rotation information obtained based on the sensor data and the rotation information obtained by analyzing the motion vectors.

According to another embodiment, the image processing apparatus may integrate the sensor data into the rotation information obtained by analyzing the motion vectors. For example, the sensor data may be integrated into a motion vector analysis result by applying a weighted value to the sensor data and the motion vector analysis result according to a relative error margin of the sensor data regarding the rotation information obtained by analyzing the motion vectors. Such a method may effectively work in a scenario in which rotation calculated by using the motion vectors may have a greater error than a measurement obtained by a sensor. For example, the above scenario may include a case where a scene includes a great area where no texture exists. In this situation, more weighted values may be applied to the sensor data. On the contrary, the sensor may have a drift problem. The drift problem may be alleviated by combining the sensor data with the rotation calculated by using the motion vectors.

FIG. 14 is a block diagram of an image processing apparatus 1400, according to an embodiment.

Referring to FIG. 14, the image processing apparatus 1400 may include at least one processor 1410 and a memory 1420. However, this is merely an example, and components of the image processing apparatus 1400 are not limited thereto.

The at least one processor 1410 may perform the method of processing the 360-degree image which is described with reference to FIGS. 1 to 13. For example, the at least one processor 1410 may obtain the motion vectors regarding a 360-degree image. The at least one processor 1410 may determine at least one motion vector indicating global rotation of the 360-degree image from among the motion vectors, through filtering. Also, the at least one processor 1410 may obtain the 3D rotation information regarding the 360-degree image by converting at least one determined motion vector. The at least one processor 1410 may correct the distortion of the 360-degree image which is caused by shaking, based on the obtained 3D rotation information.

The memory 1420 may store programs (at least one instructions) for processing and controlling the at least one processor 1410. The programs stored in the memory 1420 may be classified into modules according to their functions.

According to an embodiment, in the memory 1420, a data learner 1510 and a data recognizer 1520, which are described below with reference to FIG. 15, may be software modules. Also, the data leaner and the data recognizer may each include a learning network model or may share one learning network model.

FIG. 15 is a diagram of the at least one processor 1410, according to an embodiment.

Referring to FIG. 15, the at least one processor 1410 may include the data learner 1510 and the data recognizer 1520.

The data learner 1510 may learn standards for obtaining 3D rotation information from motion vectors regarding a 360-degree image. The data recognizer 1520 may determine the 3D rotation information from the motion vectors regarding the 360-degree image, based on the standards that are learned by the data learner 1510.

At least one of the data learner 1510 and the data recognizer 1520 may be manufactured as at least one hardware chip and embedded in the image processing apparatus. For example, at least one of the data learner 1510 and the data recognizer 1520 may be manufactured as a hardware chip exclusive for AI or part of an existing general-use processor (e.g., a central processing unit (CPU) or an application processor) or a processor exclusive for graphics (e.g., a graphic processing unit (GPU)) and may be embedded in various types of the image processing apparatuses described above.

In this case, the data learner 1510 and the data recognizer 1520 may be embedded in one image processing apparatus or may be respectively embedded in separate image processing apparatuses. For example, one of the data learner 1510 and the data recognizer 1520 may be included in one image processing apparatus, and the other thereof may be included in a server. Also, the data learner 1510 and the data recognizer 1520 may provide the data recognizer 1520 with model information constructed by the data learner 1510 or provide the data learner 1510 with data, which is input to the data recognizer 1520, as additional learning data, via wired or wireless connection.

At least one of the data learner 1510 and the data recognizer 1520 may be realized as a software module. When at least one of the data learner 1510 and the data recognizer 1520 is realized as a software module (or a program module including instructions), the software module may be stored in non-transitory computer readable media. Also, in this case, at least one software module may be provided by an operating system (OS) or a certain application. Alternatively, part of at least one software module may be provided by an OS, and the rest thereof may be provided by a certain application.

FIG. 16 is a block diagram of the data learner 1510, according to an embodiment.

Referring to FIG. 16, the data learner 1510 according to some embodiments may include a data obtainer 1610, a pre-processor 1620, a learning data selection unit 1630, a model learner 1640, and a model assessment unit 1650. However, this is merely an example, and the data learner 1510 may include more or less components than those described above.

The data obtainer 1610 may obtain at least one 360-degree image as learning data. For example, the data obtainer 1610 may obtain at least one 360-degree image from an image processing apparatus including the data learner 1510, or an external device that may communicate with the image processing apparatus including the data learner 1510.

The pre-processor 1620 may process at least one obtained 360-degree image into a preset format so that the model learner 1640 may use at least one 360-degree image obtained for learning.

The learning data selection unit 1630 may select a 360-degree image that is necessary for learning, from among pre-processed data. The selected 360-degree image may be provided to the model learner 1640. The learning data selection unit 1630 may select the 360-degree image that is necessary for learning from among pre-processed 360-degree images, according to standards that are set.

The model learner 1640 may learn standards regarding whether to determine the 3D rotation information from the motion vectors, by using some information from the 360-degree image in layers of the learning model network.

Also, the model learner 1640 may train a data determination model through, for example, reinforcement learning using feedback as to whether the obtained 360-degree image is appropriate for learning.

Also, when the data determination model is trained, the model learner 1640 may store the trained data determination model.

When assessment data is input to the data network model and a determination result output from the assessment data does not satisfy certain standards, the model assessment unit 1650 may make the model learner 1640 learn again. In this case, the assessment data may be preset data used to assess the learning network model.

At least one of the data obtainer 1610, the pre-processor 1620, the learning data selection unit 1630, the model learner 1640, and the model assessment unit 1650 of the data learner 1510 may be manufactured as at least one hardware chip and embedded in the image processing apparatus. For example, at least one of the data obtainer 1610, the pre-processor 1620, the learning data selection unit 1630, the model learner 1640, and the model assessment unit 1650 may be manufactured as a hardware chip exclusive for AI or as part of an existing general-use processor (e.g., a CPU or an application processor) or a processor exclusive for graphics (e.g., a GPU) and may be embedded in various types of the image processing apparatuses described above.

Also, the data obtainer 1610, the pre-processor 1620, the learning data selection unit 1630, the model learner 1640, and the model assessment unit 1650 may be embedded in one image processing apparatus or respectively embedded in separate image processing apparatuses. For example, some of the data obtainer 1610, the pre-processor 1620, the learning data selection unit 1630, the model learner 1640, and the model assessment unit 1650 may be included in the image processing apparatus, and the others thereof may be included in the server.

Also, at least one of the data obtainer 1610, the pre-processor 1620, the learning data selection unit 1630, the model learner 1640, and the model assessment unit 1650 may be realized as a software module. When at least one of the data obtainer 1610, the pre-processor 1620, the learning data selection unit 1630, the model learner 1640, and the model assessment unit 1650 is realized as a software module (or a program module including instructions), the software module may be stored in non-transitory computer readable media. Also, in this case, at least one software module may be provided by an OS or a certain application. Alternatively, part of at least one software module may be provided by an OS, and the rest thereof may be provided by a certain application.

FIG. 17 is a block diagram of the data recognizer 1520, according to an embodiment.

Referring to FIG. 17, the data recognizer 1520 according to some embodiments may include a data obtainer 1710, a pre-processor 1720, a recognition data selection unit 1730, a recognition result provider 1740, and a model update unit 1750.

The data obtainer 1710 may obtain at least one 360-degree image, and the pre-processor 1720 may pre-process at least one obtained 360-degree image. The pre-processor 1720 may process at least one obtained 360-degree image into a preset format to allow the recognition result provider 1740, which is described below, to use at least one obtained 360-degree image to determine 3D rotation information regarding the motion vectors. The recognition data selection unit 1730 may select a motion vector that is necessary to determine the 3D rotation information from among motion vectors included in pre-processed data. The selected motion vector may be provided to the recognition result provider 1740.

The recognition esult provider 1740 may determine the 3D rotation information based on the selected motion vector. Also, the recognition result provider 1740 may provide the determined 3D rotation information.

The model update unit 1750 may provide assessment-related information to the model learner 1640, which is described above with reference to FIG. 16, to update parameters of layers, etc. included in the learning network model, based on assessments regarding the 3D rotation information provided by the recognition result provider 1740.

At least one of the data obtainer 1710, the pre-processor 1720, the recognition data selection unit 1730, the recognition result provider 1740, and the model update unit 1750 in the data recognizer 1520 may be manufactured as at least one hardware chip and embedded in the image processing apparatus. For example, at least one of the data obtainer 1710, the pre-processor 1720, the recognition data selection unit 1730, the recognition result provider 1740, and the model update unit 1750 may be manufactured as a hardware chip exclusive for AI or part of an existing general-use processor (e.g., a CPU or an application processor) or a processor exclusive for graphics (e.g., a GPU) and may be embedded in various types of the image processing apparatuses described above.

Also, the data obtainer 1710, the pre-processor 1720, the recognition data selection unit 1730, the recognition result provider 1740, and the model update unit 1750 may be embedded in one image processing apparatus or may be respectively embedded in separate image processing apparatuses. For example, some of the data obtainer 1710, the pre-processor 1720, the recognition data selection unit 1730, the recognition result provider 1740, and the model update unit 1750 may be included in one image processing apparatus, and the others thereof may be included in the server.

Also, at least one of the data obtainer 1710, the pre-processor 1720, the recognition data selection unit 1730, the recognition result provider 1740, and the model update unit 1750 may be realized as a software module. When at least one of the data obtainer 1710, the pre-processor 1720, the recognition data selection unit 1730, the recognition result provider 1740, and the model update unit 1750 is realized as a software module (or a program module including instructions), the software module may be stored in non-transitory computer readable media. Also, in this case, at least one software module may be provided by an OS or a certain application. Alternatively, part of at least one software module may be provided by an OS, and the rest thereof may be provided by a certain application.

FIG. 18 is a block diagram of an image processing apparatus, according to another embodiment.

Referring to FIG. 18, in the present embodiment, the image processing apparatus may include a first device 1800, which analyzes a 360-degree image to determine 3D rotation information, and a second device 1810 which generates a stabilized image based on rotation provide by the first device 1800. In other embodiments, some or all components of the first device 1800 and the second device 1810 may be realized as a single physical device.

The first device 1800 may include a motion vector obtainer 1801, which obtains motion vectors regarding the 360-degree image, and a motion vector translator 1802 which translates the motion vectors into 3D rotation and provides the 3D rotation to an image processor 1811 included in the second device 1810

The second device 1810 may include the image processor 1811 and a display 1812 that displays a stabilized 360-degree image that is rendered by the image processor 1811. Also, the second device 1810 may further include an inputter 1813 configured to receive a control input of a capturing device that defines rotation and/or translation.

Methods according to the one or more embodiments may be realized as program commands executable by various computer media and recorded in a computer-readable recording medium. The computer-readable recording medium may include a program command, a data file, a data structure, or a combination thereof. The program command recorded in the medium may be specifically designed and constructed for the disclosure or may be executable because it is known to one of ordinary skill in the computer software. Examples of the computer-readable recording medium include magnetic storage media (e.g., hard disks, floppy disks, magnetic tapes, etc.), optical media (e.g., CD-ROMs, or DVDs), magneto-optical media (e.g., floptical disks), and a hardware device (e.g., ROM, RANI, flash memory, etc.) specially designed to store and execute program commands. Examples of program commands include a machine language code produced by a compiler as well as a high-level language code executable by a computer by using an interpreter.

The device described herein may include a processor, a memory for storing program data and executing it, a permanent storage unit such as a disk drive, a communications port for handling communications with external devices, and user interface devices, including a touch panel, keys, buttons, etc. When software modules or algorithms are involved, these software modules may be stored as program instructions or computer-readable codes executable on a processor on a computer-readable medium. Examples of the computer readable recording medium include magnetic storage media (e.g., ROM, floppy disks, hard disks, etc.), and optical recording media (e.g., CD-ROMs, or DVDs). The computer-readable recording medium can also be distributed over network coupled computer systems so that the computer readable code is stored and executed in a distributive manner. This media can be read by the computer, stored in the memory, and executed by the processor.

For the purposes of promoting understanding of the principles of the disclosure, reference has been made to the preferred embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art.

The present disclosure may be described in terms of functional block components and various processing steps. Such functional blocks may be realized by any number of hardware and/or software components configured to perform the specified functions. For example, the present disclosure may employ various integrated circuit (IC) components, e.g., memory elements, processing elements, logic elements, look-up tables, and the like, which may carry out a variety of functions under the control of one or more microprocessors or other control devices. Also, the present disclosure may employ cores of the same type or different types and CPUs of different types. Similarly, where the elements of the present disclosure are implemented using software programming or software elements, the disclosure may be implemented with any programming or scripting language such as C, C++, Java, assembler language, or the like, with the various algorithms being implemented with any combination of data structures, objects, processes, routines or other programming elements. Functional aspects may be implemented in algorithms that execute on one or more processors. Furthermore, the present disclosure could employ any number of conventional techniques for electronics configuration, signal processing and/or control, data processing and the like. The words “mechanism”, “element”, “means”, and “configuration” are used broadly and are not limited to mechanical or physical embodiments. However, the words can include software routines in conjunction with processors, etc.

The particular implementations shown and described herein are illustrative examples of the disclosure and are not intended to otherwise limit the scope of the disclosure in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements, and it should be noted that many alternative or additional functional relationships, physical connections or logical connections may be present in a practical device. Moreover, no item or component is essential to the practice of the disclosure unless the element is specifically described as “essential” or “critical”.

The use of the terms “a” and “an” and “the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. The present disclosure is not limited to the described order of the steps. The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to one of ordinary skill in the art without departing from the spirit and scope of the present disclosure.

1. A method of processing a 360-degree image, the method comprising:
obtaining a plurality of motion vectors regarding the 360-degree image;
determining at least one motion vector indicating global rotation of the 360-degree image from among the plurality of motion vectors, through filtering;
obtaining three-dimensional (3D) rotation information of the 360-degree image by three-dimensionally translating the determined at least one motion vector; and
correcting distortion of the 360-degree image, which is caused by shaking, based on the obtained 3D rotation information.

2. The method of claim 1, wherein the obtaining of the 3D rotation information comprises:
classifying the determined at least one motion vector into a plurality of bins corresponding to a predetermined direction and predetermined size ranges;
selecting a bin comprising the greatest number of motion vectors from among the plurality of classified bins; and
obtaining the 3D rotation information by translating a direction and a distance of the selected bin.

3. The method of claim 1, wherein the obtaining of the 3D rotation information comprises:
obtaining the 3D rotation information based on the plurality of motion vectors, by using a learning network model that is previously generated.

4. The method of claim 1, further comprising:
obtaining sensor data generated as a result of sensing shaking of a capturing device when the 360-degree image is captured, and
wherein the correcting of the 360-degree image comprises correcting the distortion of the 360-degree image by combining the obtained sensor data with the 3D rotation information.

5. An apparatus for processing a 360-degree image comprising:
a memory storing one or more instructions; and
a processor configured to execute the one or more instructions stored in the memory,
wherein the processor is configured to:
obtain a plurality of motion vectors regarding a 360-degree image;
determine at least one motion vector indicating global rotation of the 360-degree image from among the plurality of motion vectors through filtering;
obtain three-dimensional (3D) rotation information regarding the 360-degree image by three-dimensionally translating the determined at least one motion vector; and
correct distortion of the 360-degree image which is caused by shaking, based on the obtained 3D rotation information.

6. The apparatus of claim 5, wherein the processor is configured to remove a motion vector, which is included in a predetermined area, from the plurality of motion vectors according to types of projections.

7. The apparatus of claim 5, wherein the processor is configured to:
generate a mask based on an edge detected from the 360-degree image;
determine an area of the 360-degree image, where texture does not exist, by applying the generated mask to the 360-degree image; and
remove a motion vector included in the area, where texture does not exist, from among the plurality of motion vectors.

8. The apparatus of claim 5, wherein the processor is configured to
detect at least one moving object from the 360-degree image through a preset object detection process, and
remove a motion vector, which is related to the detected object, from the plurality of motion vectors.

9. The apparatus of claim 5, wherein the processor is configured to determine, as motion vectors indicating the global rotation, motion vectors that are parallel to each other on opposite sides of a unit sphere, to which the 360-degree image is projected, have different marks, and have sizes within a predetermined threshold range.

10. The apparatus of claim 5, wherein the processor is configured to:
classify the determined at least one motion vector into a plurality of bins corresponding to a predetermined direction and predetermined size ranges;
select a bin comprising the greatest number of motion vectors from among the plurality of bins; and
obtain the 3D rotation information by translating a direction and a distance of the selected bin.

11. The apparatus of claim 10, wherein the processor is configured to obtain the 3D rotation information by applying a weighted average to directions and distances of the selected bin and a plurality of adjacent bins.

12. The apparatus of claim 5, wherein the processor is configured to obtain, as the 3D rotation information, a rotation value that minimizes a sum of the determined at least one motion vector.

13. The apparatus of claim 5, wherein the processor is configured to obtain the 3D rotation information based on the plurality of motion vectors by using a learning network model that is previously generated.

14. The apparatus of claim 5, wherein the processor is configured to
obtain sensor data generated as a result of sensing shaking of a capturing device when the 360-degree image is captured, and
correct distortion of the 360-degree image by combining the obtained sensor data and the 3D rotation information.

15. A computer-readable recording medium having recorded thereon a program which, when executed by a computer, performs the method of claim 1.
